(19) United States
(12) Patent Application Publication
(10) Pub. No.: US 2013/0272206 A1
(43) Pub. Date: Oct. 17, 2013

(54) TERMINAL AND BASE STATION, METHOD THEREOF IN WIRELESS COMMUNICATION SYSTEM

(71) Applicants: Jianjun LI, Seoul (KR); Kyoungmin Park, Seoul (KR)

(72) Inventors: Jianjun LI, Seoul (KR); Kyoungmin Park, Seoul (KR)

(73) Assignee: Pantech Co., Ltd., Seoul (KR)

(21) Appl. No.: 13/978,257

(22) PCT Filed: Jan. 4, 2011
(86) PCT No.: PCT/KR11/00030

§ 371 Date: Jul. 3, 2013

(51) Int. Cl. H04W 24/10

(52) U.S. Cl. CPC H04W 24/10
USPC 370/328

(57) ABSTRACT

The present invention relates to a wireless communication system and a method for transmitting the channel state information for Base Stations included in a Coordinated Multi-Point (COMP) set in a terminal when a wireless communication system uses a CoMP scheme.

### CROSS-REFERENCE TO RELATED APPLICATION

This application is the National Stage Entry of International Application No. PCT/KR2011/000030, filed on Jan. 4, 2011, which is hereby incorporated by reference as if fully set forth herein.

### BACKGROUND

1. Field

The present invention relates to a wireless communication system and a method for transmitting and processing the channel state information for Base Stations included in a Coordinated Multi-Point (COMP) set when a wireless communication system uses a CoMP scheme.

2. Discussion of the Background

There are a number of multi-antenna transmission schemes or transmission such as transit diversity, closed-loop spatial multiplexing or open-loop spatial multiplexing. Closed-loop MIMO (CL-MIMO) relies on more extensive feedback from the terminal.

### SUMMARY

In accordance with an aspect, there is provided a method for transmitting a channel state information at a terminal in a Coordinated Multi-Point (COMP) communication system, the method comprising: receiving signals in a same frequency band from the base stations included in a CoMP set; estimating a downlink channels from the received signals from the base stations; and transmitting a joint PMI (precoding Matrix Index) from the high order configuration codebook to one base station among the base stations.

In accordance with other aspect, there is provided a terminal for transmitting a channel state information at a terminal in a Coordinated Multi-Point (COMP) communication system, the method comprising: a post decoder configured to recover a signals in a same frequency band from the base stations included in a CoMP set; and a channel estimator configured to estimate downlink channels from the received signals from the base stations, transmit a joint PMI (precoding Matrix Index) from the high order configuration codebook to one base station among the base stations.

In accordance with another aspect, there is provided a method for processing a channel state information at a base station in a Coordinated Multi-Point (COMP) communication system, the method comprising: receiving a joint PMI (precoding Matrix Index) from the high order configuration codebook for base stations included in a CoMP set from a terminal; transmitting the joint PMI to the cooperative base station among the base stations through an interface; and precoding the data symbols by one part of a precoding matrix corresponding to the joint PMI. In accordance with another aspect, there is provided a base station comprising: a scheduler configured to receive a joint PMI (precoding Matrix Index) from the high order configuration codebook for base stations included in a CoMP set from a terminal and transmit the joint PMIs to the cooperative base station among the base stations through an interface; and a precoder configured to precode the data symbols by one part of a precoding matrix corresponding to the joint PMI.

In accordance with another aspect, there is provided a method for processing a channel state information at a base station in a Coordinated Multi-Point (COMP) communication system, the method comprising: receiving a joint PMI (precoding Matrix Index) from the high order configuration codebook for base stations included in a CoMP set from a primary base station through an interface; and precoding the data symbols by one part of a precoding matrix corresponding to the joint PMI which is different from the other part of the precoding matrix by which the primary base station precodes the data symbols.

In accordance with another aspect, there is provided a base station comprising: a scheduler configured to receive a joint PMI (precoding Matrix Index) from the high order configuration codebook for base stations included in a CoMP set from a primary base station through an interface; and a precoder configured to precode the data symbols by one part of a precoding matrix corresponding to the joint PMI which is different from the other part of the precoding matrix by which the primary base station precodes the data symbols.

### BRIEF DESCRIPTION OF THE DRAWINGS

FIG. 1 conceptually illustrates a CoMP scheme applied to a wireless communication system under a multi-cell environment according to one embodiment.

FIG. 2 is the block diagram of the wireless communication system using the MIMO CoMP operation according to the other embodiment.

FIG. 3 is the downlink channel and the precoding matrices of the primary and the cooperative base stations in the wireless communication system using the MIMO CoMP operation of FIG. 2.

FIG. 4 is the flowchart of a method for feedbacking the channel state information for the terminal according to another embodiment.

FIG. 5 is the flowchart of a method for processing the channel state information and precoding the data symbols for the primary base station according to another embodiment.

FIG. 6 is the flowchart of a method for processing the channel state information and precoding the data symbols for the cooperative base station according to another embodiment.

FIG. 7 is the block diagram of the wireless communication system using the MIMO CoMP operation according to another embodiment.

FIG. 8 is the exemplary cell layout applied with the wireless communication system using the MIMO CoMP operation of FIG. 7.

FIG. 9 is the downlink channel and the precoding matrices of the primary and the cooperative base stations in the wireless communication system using the MIMO CoMP operation of FIG. 7.

FIG. 10 is the flowchart of a method for feedbacking the channel state information for the terminal according to another embodiment.

FIG. 11 is the flowchart of a method for processing the channel state information and precoding the data symbols for the primary base station according to another embodiment.

FIG. 12 is the flowchart of a method for processing the channel state information and precoding the data symbols for the cooperative base station according to another embodiment.

FIG. 13 is a block diagram of a UE apparatus according to another embodiment.

It will be appreciated that for simplicity and clarity of illustration, elements illustrated in the drawings have not necessarily been drawn to scale. For example, the dimensions of some of the elements are exaggerated relative to other elements for purposes of promoting and improving clarity and understanding. Further, where considered appropriate, reference numerals have been repeated among the drawings to represent corresponding or analogous elements.

### DETAILED DISCUSSION OF THE ILLUSTRATED EMBODIMENTS

Hereinafter, embodiments of the present invention will be described in detail with reference to the attached drawings.

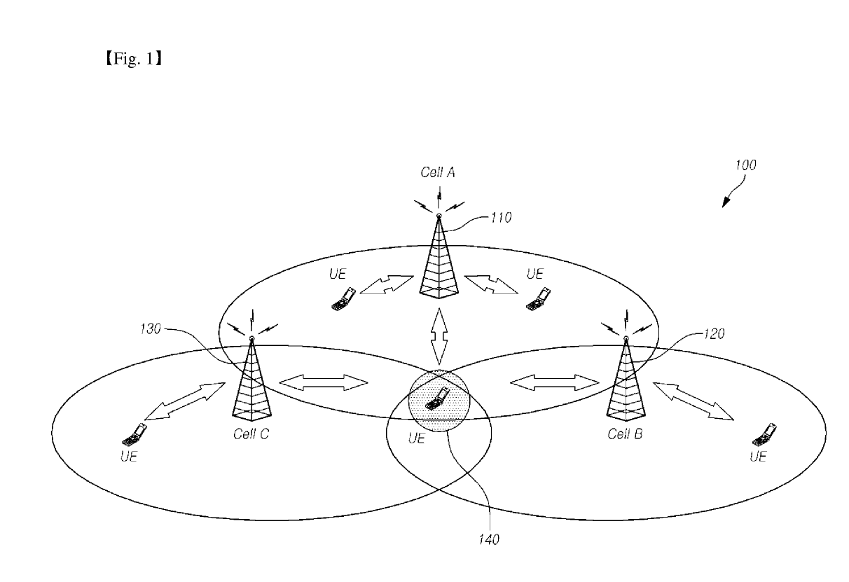

FIG. 1 conceptually illustrates a CoMP scheme applied to a wireless communication system under a multi-cell environment.

Referring to FIG. 1, there are enhanced base stations (eNBs) 110, 120 and 130 which may act as a base station or an eNB (eNB) in the multi-cell environment according to one embodiment.

The CoMP scheme is proposed to improve the throughput of a user at a cell edge by applying advanced Multiple Input Multiple Output (MIMO) under a multi-cell environment. The CoMP scheme in a wireless communication system 100 may reduce Inter-Cell Interference (ICI) in the multi-cell environment. Multi-cell base stations 110, 120 and 130 may provide joint data support to a terminal 140 by a CoMP operation. Also, each base station may improve system performance by simultaneously supporting one or more terminals 140. The terminal may act as a subscriber station or an user equipment (UE), which can be virtually any type of wireless one-way or two-way communication device such as a cellular telephone, wireless equipped computer system, and wireless personal digital assistant.

The wireless communication system may be any type of wireless communication system, including but not limited to a MIMO system, SDMA system, CDMA system, OFDMA system, OFDM system, etc. In the communication system, the wireless communication system may use closed-loop spatial multiplexing. For example a base station may implement Space Division Multiple Access (SDMA) based on Channel State Information (CSI) between the base station and terminals.

There are largely two CoMP operation modes, joint processing mode which is cooperative MIMO based on data sharing and Coordinated Scheduling/Beamforming (CS/CB) mode.

In a closed-loop wireless communication system, a terminal may measure the channel quality of a data transmission channel between the terminal and an base station, select a recommended precoding matrix (Precoding Matrix Index, PMI) for the base station, and transmit Channel Quality Information (CQI) representing the channel quality to assist the base station in selecting an appropriate Modulation and Coding Scheme (MCS) to use for the downlink transmission and the PMI to the base station. When the closed-loop wireless communication system operates in the CoMP scheme, the terminal 140 may transmit CQIs and PMIS for base stations included in a CoMP set to a primary base station, for implementing a more efficient joint processing mode.

In other words, the terminal 140 selects the precoding matrix from the codebook which has the best performance in the codebook based on the estimated channel state information (CSI).

A primary or serving base station such the base station 110 and one or more cooperative base stations such the base stations 120 and 130 that are included in a CoMP set transmit data to the terminal 140 in the same frequency band in one of CoMP operation modes, joint processing mode, for the purpose of increasing the data rate of the terminal at a cell boundary. In the joint processing mode, data transmitted from the base stations of the CoMP set and feedback information such as CQIs and PMIs transmitted from the terminal are shared among the primary base station 110 and the cooperative or neighboring base stations 120 and 130 included in the CoMP set via backhaul links.

The PMI transmission from the terminal in the joint processing mode may be considered in two ways. One is for the terminal to select PMIs for the base stations included in the CoMP set and transmit the individual PMIs to the primary base station, and the other is for the terminal to transmit a joint PMI for the base stations included in the CoMP set to the primary base station.

In the individual PMIs feedback, firstly each terminal estimates the channel from all the base stations involved in COMP set. Based on the estimated channel state information (CSI), the terminal select the PMIs from the codebook for each base station in SU-MIMO mode. After the PMIs are selected, the terminal may calculate the post SINR as CQI when combine the signals from all base stations with the selected PMIs. Then the terminal feedbacks the PMI of the select matrix and the corresponding CQI to all the base stations independently.

Based on the CSI feedback, all the base stations transmit the data symbols precoded by the respective precoding matrix from the feedback PMIs. In this case, different base stations precode the data symbols separately with same or different PMI. The MIMO structure keeps the same with the non-COMP case. Accordingly the terminal need feedback the PMI for each base station separately. So the overhead is high.

Data reception at the terminal from the individual base stations of the CoMP set is virtually equivalent to data reception at the terminal from one transmission point because the base stations transmit the data in the same frequency band. Accordingly, feedback overhead between the terminal and the base stations may be reduced. Or the terminal may select PMIs more accurately by transmitting one joint PMI for channels as feedback information, instead of individual PMIs for the channels.

Accordingly, a joint PMI that the terminal selects and transmits in the joint processing mode will be defined and exemplary embodiments of the present invention for using a joint PMI will be provided below.

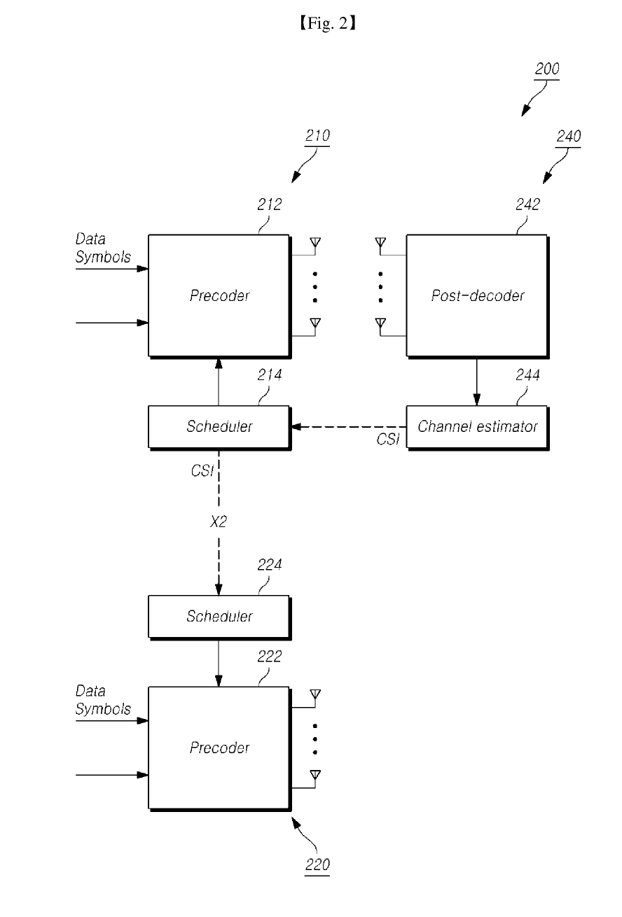

FIG. 2 is the block diagram of the wireless communication system using the MIMO CoMP operation according to the other embodiment.

Referring to FIG. 2, the wireless communications system 200 according to one embodiment may support multi-user multiple-input multiple-output (MU-MIMO) CoMP operation where a primary base station 710 and one or more cooperative base station 220 that are included in a CoMP set transmit data to a terminal 240 in the same frequency band in joint processing mode.

The terminal 240 may comprise a channel estimator 244 and a post-decoder 242.

The terminal 240 may estimate the precoded channel by DM-RS (Demodulation-reference signal). Then the terminal 240 may recover the original data symbols by post-decoder 244 with precoded channel information.

The channel estimator 242 of the terminal 240 estimates the downlink channels from all the base stations 210 and 220 involved in COMP operation based on the reference signals such as CSI-RS (Channel status Indicator-Reference Signal) from both the primary base station 210 and the cooperative base station 220. Based on the estimated channel, the channel estimator 242 may select the joint PMI from the high order or larger antenna configuration codebook for SU-MIMO operation. In general if one of the base stations has n Tx (n is one or more natural number) and the other of the base stations has m Tx (m is one or more natural number), the n+m Tx codebook may be used so that the channel estimator 242 may select the joint PMI from the high order configuration codebook for SU-MIMO operation. Both the n and the m are equal with each other but not limited therewith. For example, if each of the base stations 210 and 220 has 4 transmitting antennas (4Tx), the 8 transmitting antennas (8Tx) is configuration codebook may be used. For other example, 2 Tx for each of the base stations 210 and 220 corresponds to 4Tx configuration codebook.

After the channel estimator 242 selects the joint PMI from the high order configuration codebook, the channel estimator 242 may calculate the post SINR as CQI for the selected PMI when combine all the signals from all the base stations in the CoMP set. Then the channel estimator 242 feedback the joint PMI selected from the high order configuration codebook and the corresponding CQI as the channel state information to the primary base station 210.

As described above, if each of the base stations 210 and 220 has 4 transmitting antennas (4Tx), the 8 transmitting antennas (8Tx) codebook may be used. When the 8 transmitting antennas (8Tx) configuration codebook may use two stage precoding codebook, there are two corresponding codebooks for 8Tx (8 transmitting antennas), one C1 for wideband and the other C2 for subband.

The wideband codebook C1 is not unitary which consist of DFT beams. The subband codebook C2 is vectors for beam selection and co-phasing. The final precoding matrix when harmonized C1 and C2 is DFT beams with extension by different co-phasing.

The wideband codebook C1 may include the precoding matrices W1 and the corresponding indices PMI1s to the precoding matrices W1. The subband codebook C2 may include the precoding matrices W2 and the corresponding indices PMI2s to the precoding matrices W2.

These two precoding scheme may be jointly performed by two precoding matrices as follow:

W=W1W2

To support better adaptation of precoding matrix in frequency domain, the channel estimator 242 may report several DFT beams in frequency-selective manner via PMI1. In this approach, PMI1 reports bundles of DFT beams which would be neighboring beams.

According to this embodiment, for Rank 1, 2 and 4, the primary base station may precode the data symbols by using one part of the final precoding matrix and the cooperative base station may precode the data symbols by using other part of the final precoding matrix.

For example, the primary base station may precode the data symbols by using the selected DFT beams. The cooperative base station may play the co-phasing part. As described above, the primary base station may precode the data symbols by using the selected DFT beams and the cooperative base station may play the co-phasing part, but not limited thereof. For example the primary base station may play the co-phasing part and the cooperative base station may precode the data symbols by using the selected DFT beams.

As a example of rank 1, the first precoding matrix W1 may be [X 0; 0 X] block diagonal as follows.

$${W}_{1}^{( k )} = [ \begin{matrix}{X}^{( k )} & 0 \\ 0 & {X}^{( k )}\end{matrix} ]$$

Wherein the X is 4×Nb matrix, the Nb is 4 adjacent overlapping beams (the subset W1) and the 0 is 4×4 zero matrix. The adjacent overlapping beams are used to reduce edge effect in frequency-selective precoding.

There are 32 4Tx DFT beams for X (oversampled 8×) wherein beam index is 0, 1, 2, . . . , 31.

$$B = [ \begin{matrix}{b}_{0} & {b}_{1} & … & {b}_{31}\end{matrix} ] , {[ B ]}_{1 + m , 1 + n} = {e}^{j \frac{2 π mn}{32 }} , \\ m = 0 , 1 , 2 , 3 , n = 0 , 1 , … , 31$$

Where [B] p,q is the value of the p-th of row and the q-th column of 32*4 matrix B. For example, b0=(1, 1, 1, 1), b1=(1, e^{j(π/16)}, e^{j(2π/16)}, e^{j(3π/16))}, b2=(1, e^{j(2π/16)}, e^{j(4π/16)}, e^{j(6π/16)}), . . . , b31=(1, e^{j(31π/16)}, e^{j(62π/16)}, e^{j(93π/16)})

$${X}^{( k )} ∈ \{ ⌊ \begin{matrix}{b}_{2 k mod 32} & {b}_{( 2 k + 1 ) mod 32} & {b}_{( 2 k + 2 ) mod 32} & {b}_{( 2 k + 3 ) mod 32}\end{matrix} ⌋ \text{:} k = 0 , 1 , … , 15 \}$$

There are sixteen W1 matrices per rank: {0, 1, 2, 3}, {2, 3, 4, 5}, {4, 5, 6, 7}, . . . , {28, 29, 30, 31}, {30, 31, 0, 1}. There are sixteen PMI1s, for example PMI1=0, PMI1=1, PMI1=2, . . . , PMI1=14, PMI1=15.

$$W {1}_{PMI 1 = n} = [ \begin{matrix}{b}_{2 n} & {b}_{2 n + 1} & {b}_{2 n + 2} & {b}_{2 n + 3} & \overline{0} & \overline{0} & \overline{0} & \overline{0} \\ \overline{0} & \overline{0} & \overline{0} & \overline{0} & {b}_{2 n} & {b}_{2 n + 1} & {b}_{2 n + 2} & {b}_{2 n + 3}\end{matrix} ]$$

The second precoding matrix W2 may select one of adjacent overlapping beams and perform a co-phasing. PMI2 reports which beam belongs to the subset W1 should be used in each subband and how to perform phase adaptation between co-polarized antenna domains or groups.

For rank 1, W2 may be as follows:

$$W 2 = [ \begin{matrix}Y \\ α Y\end{matrix} ]$$

Where Y is a beam selection vector which selects one of adjacent overlapping beams for the first precoding matrix W1 and α is a co-phase element which performs phase adaptation between co-polarized domains.

For example, if α is one of 1, −1, j or −j, W2 may be as follows:

$${W}_{2} ∈ {C}_{2} = \{ \frac{1}{\sqrt{2}} [ \begin{matrix}Y \\ Y\end{matrix} ] , \frac{1}{\sqrt{2}} [ \begin{matrix}Y \\ j Y\end{matrix} ] , \frac{1}{\sqrt{2}} [ \begin{matrix}Y \\ - Y\end{matrix} ] , \frac{1}{\sqrt{2}} [ \begin{matrix}Y \\ - j Y\end{matrix} ] \}$$

The \tilde{e}ₙ is a 4×1 selection vector with all zeros except for the n-th element with value 1.

$$Y ∈ \{ \begin{matrix}1 & 0 & 0 & 0 \\ 0 & 1 & 0 & 0 \\ {0}^{′} & {0}^{′} & {1}^{′} & 0 \\ 0 & 0 & 0 & 1\end{matrix} \}$$

There are sixteen W2 matrices which are four elements by four 4×1 selection vectors. There are sixteen PMI2s, for example PMI2=0, PMI2=1, PMI2=2, . . . , PMI2=14, PMI2=15.

Therefore the final precoding matrix W which combines between the first precoding matrix W1 and the second precoding matrix W2 may be as follows:

$$W = [ \begin{matrix}{X}^{( k )} Y \\ α {X}^{( k )} Y\end{matrix} ]$$

As described above, the channel estimator 242 feedbacks the joint PMIs of a dual stage precoder such PMI1 and PMI2 from the high order configuration codebook such as 8TX configuration codebook and the corresponding CQI as the channel state information (CSI) report to the primary base station 210.

As described above, the precoder may be a dual stage precoder and the joint PMI is the PMIs of a dual stage precoder which shared by all the base stations (eNBs) included in the CoMP set, but not limited thereof. The precoder may be one stage precoder and the joint PMI may be the PMI of one stage precoder. For example, if each of the base stations 210 and 220 has 2 transmitting antennas (2 Tx), the 4 transmitting antennas (4Tx) configuration codebook may be used. In this case the 4 transmitting antennas (4Tx) configuration codebook may comprise only one codebook of the precoding matrices and their corresponding indices.

Based on the CSI report, the primary base station 210 transmit the PMIs of a dual stage precoder and CQI information to the cooperative base stations 220 in CoMP set by X2 interface. The primary base station 210 and cooperative 220 base station jointly precode the data symbols by one part of the final precoding matrix corresponding to the joint PMI. That is, each base station only uses part of the final precoding matrix.

The primary base station may precode the data symbols by X(k)Y and the cooperative base station may precode the data symbols by αX(k)Y(αε{1, −1, j, −j} and the reverse.

For example if the channel estimator 242 feedbacks the joint PMIs such as PMI1=2 and PMI2=1, the final precoding matrix W=W1×W2 is as follows:

$$W = W 1 \times W 2 = [ \begin{matrix}{b}_{4} & {b}_{5} & {b}_{6} & {b}_{7} & \overline{0} & \overline{0} & \overline{0} & \overline{0} \\ \overline{0} & \overline{0} & \overline{0} & \overline{0} & {b}_{4} & {b}_{5} & {b}_{6} & {b}_{7}\end{matrix} ] \times [ \begin{matrix}1 \\ 0 \\ 0 \\ 0 \\ 1 \\ 0 \\ 0 \\ 0\end{matrix} ] = [ \begin{matrix}{b}_{4} \\ {b}_{4}\end{matrix} ]$$

Both the primary base station and the cooperative base station may precode the data symbols by b4=(1, e^{j(8π/16)}, e^{j(10π/16)}, e^{j(12π/16)}).

Based on the feedback, the primary base station transmit the PMI and CQI information to the cooperative base stations in COMP set through X2 interface.

For Rank 3 and 4, the first precoding matrix W1 may be [X 0; 0 X] block diagonal as follows.

$${W}_{1}^{( k )} = [ \begin{matrix}{X}^{( k )} & 0 \\ 0 & {X}^{( k )}\end{matrix} ]$$

wherein the X is 4×Nb matrix, the Nb is 8 adjacent overlapping beams (the subset W1) and the 0 is 4×8 zero matrix. There are 16 4Tx DFT beams for X (oversampled 4×) wherein beam index is 0, 1, 2, . . . , 15.

$$B = [ \begin{matrix}{b}_{0} & {b}_{1} & … & {b}_{15}\end{matrix} ] , {[ B ]}_{1 + m , 1 + n} = {e}^{j \frac{π mn}{16}} , \\ m = 0 , 1 , 2 , 3 , n = 0 , 1 , … 15$$

Where [B] p,q is the value of the p-th of row and the q-th column of 32*4 matrix B. For example, b0=(1, 1, 1, 1), b1=(1, e^{j(2π/16)}, e^{j(4π/16)}, e^{j(6π/16)}), b2=(1, e^{j(4π/16)}, e^{j(8π/16)}, e^{j(12π/16)}) . . . , b31=(1, e^{j(62π/16)}, e^{j(124π/16)}, e^{j(186π/16)})

X^{(k)}ε{└b_{4k mod 16}b_{(4k+1)mod 16} . . . b_{(4k+7)mod 16}┘:k=0,1,2,3}

There are eight W1 matrices per rank: {0, 1, 2, . . . , 7}, {4, 5, 6, . . . , 11}, {8, 9, 10, . . . , 15}, {12, 13, 14, 15, 0, . . . , 3}

There are four PMI1s, for example PMI1=0(W1(0)), PMI1=1(W1(1)), PMI1=2(W1(2)), PMI1=3(W1(3)).

For rank 3, W2 may be as follows:

$$W 2 = [ \begin{matrix}{Y}_{1} & {Y}_{2} \\ {Y}_{1} & a {Y}_{2}\end{matrix} ]$$

For example, if α is −1, W2 may be as follows:

$${W}_{2} ∈ {C}_{2} = \{ \frac{1}{\sqrt{2}} [ \begin{matrix}{Y}_{1} & {Y}_{2} \\ {Y}_{1} & - {Y}_{2}\end{matrix} ] \}$$

$$( {Y}_{1} , {Y}_{2} ) ∈ \{ \begin{matrix}( {e}_{1} , [ {e}_{1} {e}_{5} ] ) , ( {e}_{2} , [ {e}_{2} {e}_{6} ] ) , ( {e}_{3} , [ {e}_{3} {e}_{7} ] ) , ( {e}_{4} , [ {e}_{4} {e}_{8} ] ) , \\ ( {e}_{5} , [ {e}_{1} {e}_{5} ] ) , ( {e}_{6} , [ {e}_{2} {e}_{6} ] ) , ( {e}_{7} , [ {e}_{3} {e}_{7} ] ) , ( {e}_{8} , [ {e}_{4} {e}_{8} ] ) , \\ ( [ {e}_{1} {e}_{5} ] , {e}_{5} ) , ( [ {e}_{2} {e}_{6} ] , {e}_{6} ) , ( [ {e}_{3} {e}_{7} ] , {e}_{7} ) , ( [ {e}_{4} {e}_{8} ] , {e}_{8} ) , \\ ( [ {e}_{5} {e}_{1} ] , {e}_{1} ) , ( [ {e}_{6} {e}_{2} ] , {e}_{2} ) , ( [ {e}_{7} {e}_{3} ] , {e}_{3} ) , ( [ {e}_{8} {e}_{4} ] , {e}_{4} )\end{matrix} \}$$

It should be noted that the dimension of Y1 and Y2 are not same. If (Y1,Y2)=(e1,[e1,e5]), then Y1=e1, Y2=[e1,e5].

The \tilde{e}ₙ is an 8×1 selection vector with all zeros except for the n-th element with value 1.

There are sixteen W2 matrices which are one element by sixteen 8×1 selection vectors. There are sixteen PMI2s, for example PMI2=0, PMI2=1, PMI2=2, . . . , PMI2=14, PMI2=15.

Therefore the final precoding matrix W which combines between the first precoding matrix W1 and the second precoding matrix W2 may be as follows:

$$W 2 = [ \begin{matrix}{X}^{( k )} {Y}_{1} & {X}^{( k )} {Y}_{2} \\ {X}^{( k )} {Y}_{1} & - {X}^{( k )} {Y}_{2}\end{matrix} ]$$

As described above, the channel estimator 242 feedbacks the joint PMIs such PMI1 and PMI2 from the high order configuration codebook such as 8TX configuration codebook and the corresponding CQI as the channel state information (CSI) report to the primary base station 210. The channel estimator 242 may transmit an RI (Rank indicator) including information about a rank change in the final precoding matrix W.

The primary base station may precode the data symbols by using the selected DFT beams. The primary base station may precode the data symbols by X(k)[Y1 Y2]. The cooperative base station may make it orthogonal. The cooperative base station may precode the data symbols by X(k)[Y1 −Y2].

For example if the channel estimator 242 feedbacks the joint PMIs such as PMI1=0 and PMI2=0, the final precoding matrix W=W1×W2 is as follows:

$$W = [ \begin{matrix}{b}_{0} & {b}_{0} & {b}_{4} \\ {b}_{0} & - {b}_{0} & - {b}_{4}\end{matrix} ]$$

The primary base station may precode the data symbols by [b0, b0, b4]. The cooperative base station may make it orthogonal. The cooperative base station may precode the data symbols by [b0, −b0, −b4].

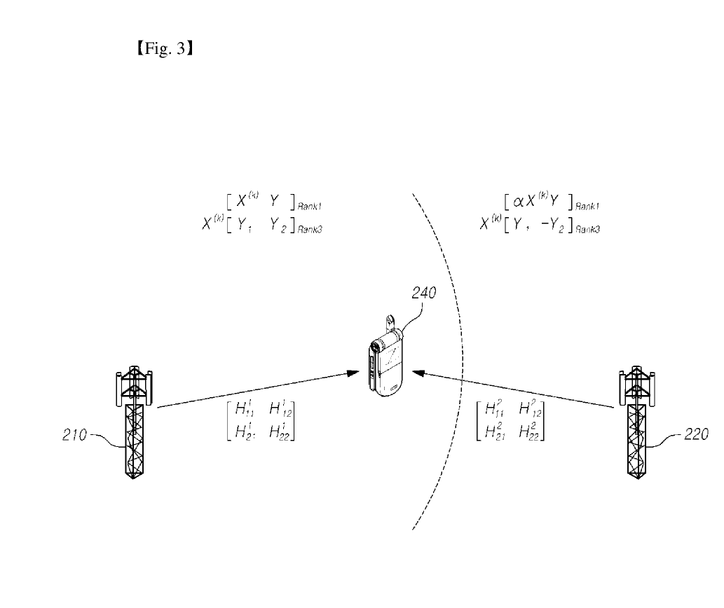

FIG. 3 is the downlink channel and the precoding matrices of the primary and the cooperative base stations in the wireless communication system using the MIMO CoMP operation of FIG. 2

Referring to FIG. 2 and FIG. 3, The primary base station 210 may comprise a precoder 212 and a scheduler 214.

The scheduler 214 may receive the channel state information such as the joint PMI and the CQI from the channel estimation 244 of the terminal 240. Then the scheduler 214 may transmit or forward the joint PMI and CQI to the cooperative base stations in COMP set by X2 interface.

Based on the CSI feedback, the precoder 212 may precode the data symbols by using the selected DFT beams. For rank 1 the precoder 212 may precode the data symbols by X(K)Y. For example if the channel estimator 242 feedbacks the joint PMIs such as PMI1=2 and PMI2=1, the precoder 212 may precode the data symbols by using the selected DFT beam b4=(1, e^{j(8π/16)}, e^{j(10π/16)}, e^{j(12π/16)}).

For rank 3 the precoder 212 may precode the data symbols by X(K)[Y1 Y2]. If the channel estimator 242 feedbacks the joint PMIs such as PMI1=0 and PMI2=0, the precoder 212 may precode the data symbols by [b0, b0, b4].

The cooperative base station 220 may comprise a precoder 222 and a scheduler 224.

The scheduler 224 may receive the joint PMIs and CQI from the primary base station in the COMP set by X2 interface.

The precoder 222 may precode the data symbols by αX(K)Y(αε{1, −1, j, −j}). For example if the scheduler 224 may receive the joint PMIs such as PMI1=2 and PMI2=1 from the primary base station in the COMP set by X2 interface, the precoder 222 may precode the data symbols by using the selected DFT beam b4=(1, ej(8π/16), ej(10π/16), ej(12π/16)).

For rank 3, the precoder 222 may precode the data symbols by X(K)[Y1 −Y2].

The cooperative base station may make it orthogonal. If the channel estimator 242 feedbacks the joint PMIs such as PMI1=0 and PMI2=0, the precoder 222 may precode the data symbols by [b0, −b0, −b4].

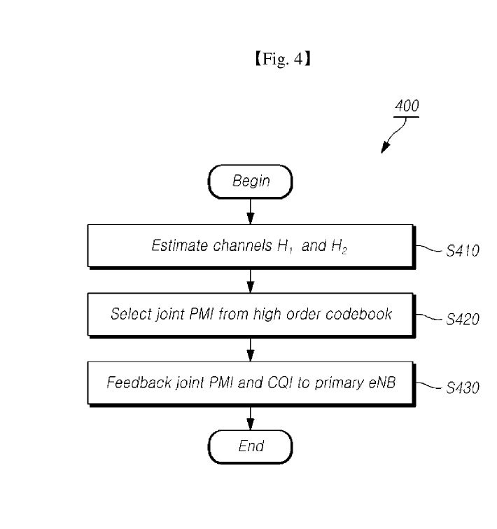

FIG. 4 is the flowchart of a method for feedbacking the channel state information for the terminal according to another embodiment.

Referring to FIG. 4, in the method for feedbacking the channel information for the terminal according to another embodiment 400, the terminal may estimate a downlink channels from all the base stations involved in the COMP operation based on the reference signals such as CSI-RS (Channel status Indicator-Reference Signal) from both the primary base station and the cooperative base station at 5410. The terminal may be the terminal 240 and the base stations may be the base stations 210 and 220 as drown in FIG. 2.

Based on the estimated channel, the terminal may select the joint PMI of the favorite matrix in the high order configuration codebook for SU-MIMO operation at 5420. In general if one of the base stations has n Tx (n is one or more natural number) and the other of the base stations has m Tx (m is one or more natural number), the n+m Tx codebook may be used so that the terminal may select the joint PMI from the high order configuration codebook for SU-MIMO operation. Both the n and the m are equal with each other but not limited therewith. For example, if each of the base stations has 4 transmitting antennas (4Tx), the 8 transmitting antennas (8Tx) configuration codebook may be used. For other example, 2 Tx for each of the base stations corresponds to 4Tx configuration codebook.

As described above, if each of the base stations has 4 transmitting antennas (4 Tx), the 8 transmitting antennas (8Tx) codebook may be used. When the 8 transmitting antennas (8Tx) configuration codebook may use two stage precoding codebook, there are two corresponding codebooks for 8Tx (8 transmitting antennas), one C1 for wideband and the other C2 for subband.

The wideband codebook C1 is not unitary which consist of DFT beams. The subband codebook C2 is vectors for beam selection and co-phasing. The final precoding matrix when harmonized C1 and C2 is DFT beams with extension by different co-phasing. The second precoder matrix may select one of adjacent overlapping beams and perform a co-phasing. The second PMI2 reports which beam belongs to the subset W1 should be used in each subband and how to perform phase adaptation between co-polarized domains.

These two precoding scheme may be jointly performed by two precoding matrices as follow:

W=W1W2

As an example of rank 1, the final precoding matrix W which combines between the first precoding matrix W1 and the second precoding matrix W2 may be as follows:

$$W = [ \begin{matrix}{X}^{( k )} Y \\ α {X}^{( k )} Y\end{matrix} ]$$

The above part X(k)Y of the final precoding matrix W may be used for precoding the data symbols of the primary base station, the below part αX(k)Y(αε{1, −1, j, −j}) of the final precoding matrix W may be used for precoding the data symbols of the cooperative base station and the reverse.

For rank 3 the final precoding matrix W may be as follows:

$$W 2 = [ \begin{matrix}{X}^{( k )} {Y}_{1} & {X}^{( k )} {Y}_{2} \\ {X}^{( k )} {Y}_{1} & - {X}^{( k )} {Y}_{2}\end{matrix} ]$$

The above part X(k)[Y1 Y2] of the final precoding matrix W may be used for precoding the data symbols of the primary base station, the below part X(k)[Y1 −Y2] of the final precoding matrix W may be used for precoding the data symbols of the cooperative base station and the reverse.

After the terminal selects the joint PMI from the high order configuration codebook, the terminal may calculate the post SINR as CQI for the selected PMI when combine all the signals from all the base stations in the CoMP set.

Then the terminal may feedback the joint PMI selected from the high order configuration codebook and the corresponding CQI as the channel state information to the primary base station at S430. The terminal may transmit an RI (Rank indicator) including information about a rank change in the final precoding matrix W as the channel state information.

The channel state information may be possible for either periodic or aperiodic CQI reporting using the PUCCH or the PUSCH. The PMI is reported along with one or more the CQI and the RI but not limited thereof. The PMI is reported without other.

As described above, the precoder may be a dual stage precoder and the joint PMI is the joint PMIs of a dual stage precoder which shared by all the base stations (eNBs) included in the CoMP set, but not limited thereof. The precoder may be one stage precoder and the joint PMI may be the joint PMI of one stage precoder. For example, if each of the base stations has 2 transmitting antennas (2Tx), the 4 transmitting antennas (4Tx) configuration codebook may be used. In this case 4 transmitting antennas (4Tx) configuration codebook may comprise only one codebook of the precoding matrices and their corresponding index.

The terminal may estimate the precoded channel by DM-RS. Then terminal may recover the original data symbols by post-decoder with precoded channel information although not drawn in Figures.

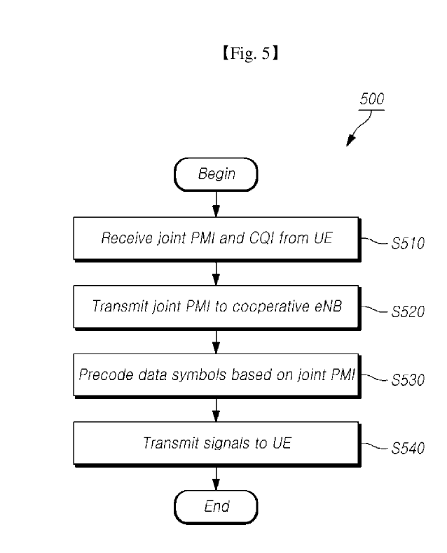

FIG. 5 is the flowchart of a method for processing the channel state information and precoding the data symbols for the primary base station according to another embodiment.

Referring to FIG. 5, in the method for processing the channel information and precoding the data symbols for the primary base station according to another embodiment 500, the primary base station may receive the channel state information such as the joint PMI and the CQI from the terminal at 5510. The primary base station may be the primary base station of FIGS. 1 to 3.

Then the primary base station may transmit or forward the joint PMI and CQI to the cooperative base stations in COMP set through any kind of interface such as X2 interface at S520.

Based on the CSI feedback, the primary base station may precode the data symbols by one part of the final precoding matrix corresponding to the joint PMI at 5530 and transmit the signal to the terminal with corresponding antennas at 5540.

At S530 the primary base station may precode the data symbols by using the selected DFT beams. For rank 1 the primary base station may precode the data symbols by X(k)Y. For example if the terminal feedbacks the joint PMIs such as PMI1=2 and PMI2=1, the primary base station may precode the data symbols by using the selected DFT beam b4=(1, e^{j(8π/16)}, e^{j(10π/16)}, e^{j(12π/16)}).

For rank 3 the primary base station may precode the data symbols by X(k)[Y1 Y2]. The primary base station may precode the data symbols by using the selected DFT beam [b0, b0, b4].

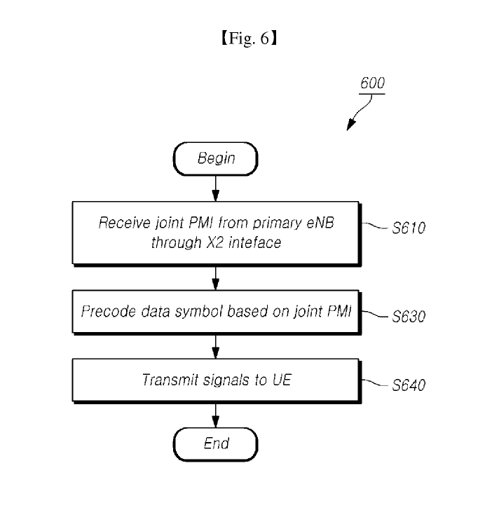

FIG. 6 is the flowchart of a method for processing the channel information and precoding the data symbols for the cooperative base station according to another embodiment.

Referring to FIG. 6, in the method for processing the channel information and precoding the data symbols for the primary base station according to another embodiment 600, the cooperative base station may receive the joint PMIs and corresponding CQI from the primary base station in the COMP set through X2 interface at 5610.

Based on the CSI feedback through X2 interface at 5610, the cooperative base station may precode the data symbols by one part of the precoding matrix corresponding to the joint PMI at 5630 and transmit the signal to the terminal with corresponding antennas at 5640.

For rank 1, the cooperative base station may precode the data symbols by one part of the precoding matrix corresponding to the joint PMI, for example αX(k)Y(αε{1, −1, j, −j}). For example if the cooperative base station may receive the joint PMIs such as PMI1=2 and PMI2=1 from the primary base station in COMP set by X2 interface, the cooperative base station may precode the data symbols by using the selected DFT beam b4=(1, e^{j(8π/16)}, e^{j(10 π/16)}, e^{j(12π/16)}).

For rank 3, the cooperative base station may precode the data symbols by one part of the precoding matrix corresponding to the joint PMI, for example X(k)[Y1 Y2]. The cooperative base station may make it orthogonal. The cooperative base station may precode the data symbols by using the selected DFT beam [b0, −b0, −b4].

For rank 3 different beams will be transmitted by the cooperative base station. The cooperative base station transmits half part of precoder to make it orthogonal. An other way is, for ULA, In order not to add new feedback, it's better that the primary base station transmits 2 beams, and the cooperative base station transmits only one beam.

If the terminal has 8 Rx antennas, rank 5˜8 can be supported by CoMP with only 4Tx eNBs. In this case, rank 5 to rank 8 codebooks may be used for higher data rate.

As described above, the use of the joint PMI from the high order or larger antenna configuration codebook may reduce the feedback overhead of the channel state information from the terminal. Also all the antennas from different base stations jointly precode the data symbols by larger antenna configuration codebook with high order MIMO operation to obtain the better system performance.

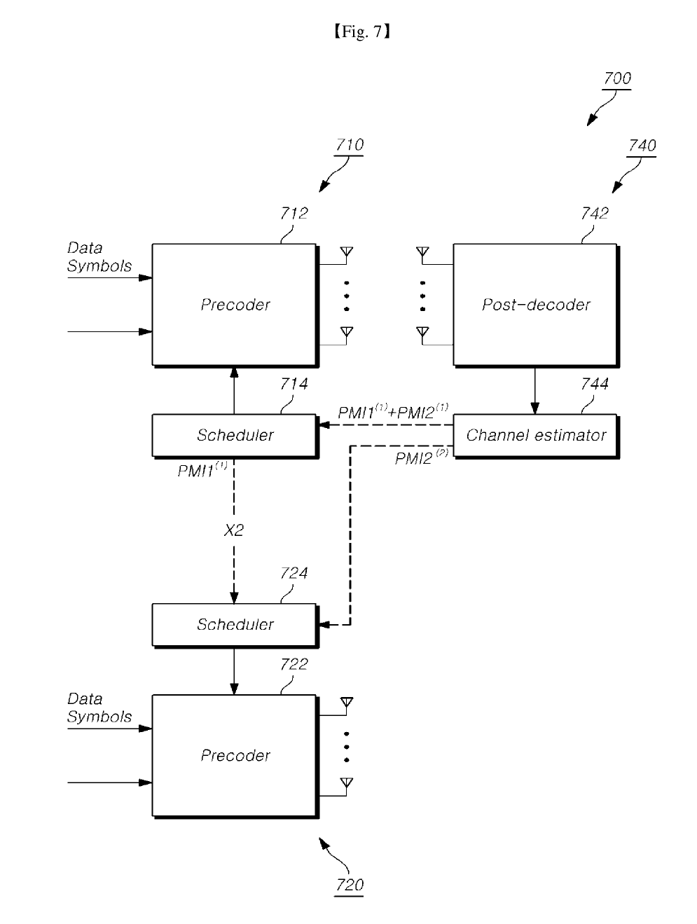

FIG. 7 is the block diagram of the wireless communication system using the MIMO CoMP operation according to another embodiment.

Referring to FIG. 7, the wireless communications system 700 according to another embodiment may support multi-user multiple-input multiple-output (MU-MIMO) CoMP operation where a primary base station 710 and one or more cooperative base station 720 that are included in a CoMP set transmit data to a terminal 740 in the same frequency band in joint processing mode.

The terminal 740 may comprise a channel estimator 742 and a post-decoder 744.

The terminal 740 may estimate the precoded channel by DM-RS. Then the terminal 740 may recover the original data symbols by post-decoder 744 with precoded channel information.

The channel estimator 742 of the terminal 740 estimates the downlink channels from all the base stations 710 and 720 involved in the COMP operation based on the reference signals such as CSI-RS (Channel status Indicator-Reference Signal) from both the primary base station 710 and the cooperative base station 720. Based on the estimated channel, the channel estimator 742 may select the best SU-MIMO PMIs for the primary base station. After the PMIs for the primary base station is decided, the channel estimator 742 may select the PMI for the cooperative base station which can provide the maximum enhancement to signal of the primary base station at the UE side.

After the channel estimator 742 selects the PMIs for the primary base station and the PMIs for the cooperative base station, the channel estimator 742 may calculate the post SINR as CQI for the selected PMIs when combine all the signals from all the base stations in the CoMP set. Then the channel estimator 742 feedback the PMIs of the selected matrix and the corresponding CQI as the channel state information to the primary base station 710.

As described above, when the 8 transmitting antennas (8Tx) configuration codebook may use two stage precoding codebook, there are two corresponding codebooks for 8Tx (8 transmitting antennas), one C1 for wideband and the other C2 for subband.

The wideband codebook C1 is not unitary which consist of DFT beams. The subband codebook C2 is vectors for beam selection and co-phasing. The final precoding matrix when harmonized C1 and C2 is DFT beams with extension by different co-phasing.

These two precoding scheme may be jointly performed by both of two precoding matrices as follow:

W=W1W2

As an example of rank 1, the final precoding matrix W which combines the first precoding matrix W1 and the second precoding matrix W2 may be as follows:

$$W = [ \begin{matrix}{X}^{( k )} Y \\ α {X}^{( k )} Y\end{matrix} ]$$

For rank 3 the final precoding matrix W may be as follows:

$$W 2 = [ \begin{matrix}{X}^{( k )} {Y}_{1} & {X}^{( k )} {Y}_{2} \\ {X}^{( k )} {Y}_{1} & - {X}^{( k )} {Y}_{2}\end{matrix} ]$$

If the channel from the primary base station and the cooperative base station is H1 and H2 respectively, the PMIs of the primary base station W2(1) and W2(1) comes from:

$$[ \begin{matrix}{W}_{1}^{( 1 )} & {W}_{2}^{( 1 )}\end{matrix} ] = {argmax}_{{{W}_{1} ∈ {C}_{1}}_{{W}_{2} ∈ {C}_{2}}} ( ‖ {H}_{1} {W}_{1} {W}_{2} ‖ )$$

The PMIs of the cooperative base station W2(1) and W2(1) comes from:

$$[ \begin{matrix}{W}_{1}^{( 2 )} & {W}_{2}^{( 2 )}\end{matrix} ] = {argmax}_{{{W}_{1} ∈ {C}_{1}}_{{W}_{2} ∈ {C}_{2}}} ( ‖ {H}_{1} {W}_{1}^{( 1 )} {W}_{2}^{( 1 )} + {H}_{2} {W}_{1} {W}_{2} ‖ )$$

By the 8Tx codebook of the two stage precoding, the cooperative base station may share the first PMI(1) plus one shift. If the codebook size is N, W₁⁽²⁾=mod(W₁⁽¹⁾+P,N) where P is the shift.

So only the second PMI2(2) need be feedback to the cooperative base station. The second PMI2(2) for the cooperative base station can be as follows:

$${W}_{2}^{( 2 )} = {argmax}_{{W}_{2} ∈ {C}_{2}} ( ‖ {H}_{1} {W}_{1}^{( 1 )} {W}_{2}^{( 1 )} + {H}_{2} {W}_{1}^{( 2 )} {W}_{2} ‖ )$$

The shift is based on the relative position of the primary base station and the cooperative base station in cell layout for the CoMP operation.

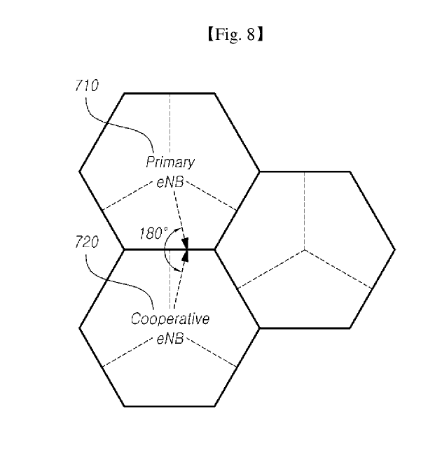

FIG. 8 is the exemplary cell layout applied to the wireless communication system using the MIMO CoMP operation of FIG. 7.

Referring to FIG. 8 the direction of different base stations for inter-COMP for 360 degree beam is about 180 degree. So the shift is about P=N/2.

There are 32 4Tx DFT beams for X (oversampled 8×) wherein beam index is 0, 1, 2, . . . , 31.

$$B = [ \begin{matrix}{b}_{0} & {b}_{1} & … & {b}_{31}\end{matrix} ] , {[ B ]}_{1 + m , 1 + n} = {e}^{j \frac{2 xmn}{32}} , \\ m = 0 , 1 , 2 , 3 , n = 0 , 1 , … , 31$$

In other words each of 32 4Tx DFT beams for X is divided into 360 degree by 32 so that the difference of the direction between the xth 4Tx DFT and the (x+N/2)th beams is 180 degree. The shift with P=N/2 of the first PMI1(1) for the cooperative base station reflects that the direction of different base stations for inter-COMP is about 180 degree.

The second PMI2 of cooperative base station may select the beam with high accurate direction among the Nb adjacent overlapping beams.

If the downlink channels from all the base stations is H1=[1, 0.8315−0.5556i, 0.3827−0.9239i, −0.1951−0.9808i, 1, 0.8315−0.5556i, 0.3827−0.9239i, −0.1951−0.9808i] and H2=[1, 0.5556+0.8315i, −0.3827−0.9239i, 0.9808+0.1951i, 1, 0.5556+0.8315i, −0.3827−0.9239i, 0.9808+0.1951i], the PMIs for primary base station may be PMI1(1)=1 and PMI2(1)=4;

They cooperative base station share the first PMI with primary base station plus one shift, so PMI1(2)=mod(1+16/2, 16)=9, the maximum gain by the second PMI of the cooperative base station may be PMI2(2)=12 to get the maximum gain.

Then the channel estimator 742 feedback the PMI1(1)=1 and PMI2(1)=4 and the corresponding CQI to the primary base station. The channel estimator 742 only feedback the second PMI2(2)=12 to the cooperative base station. The channel estimator 742 does not feedback the first PMI1(2)=9 of the cooperative base station to any base stations in the CoMP set.

The channel state information may be possible for either periodic or aperiodic CQI reporting using the PUCCH or the PUSCH. The PMI is reported along with one or more the CQI and the RI but not limited thereof. The PMI is reported without other.

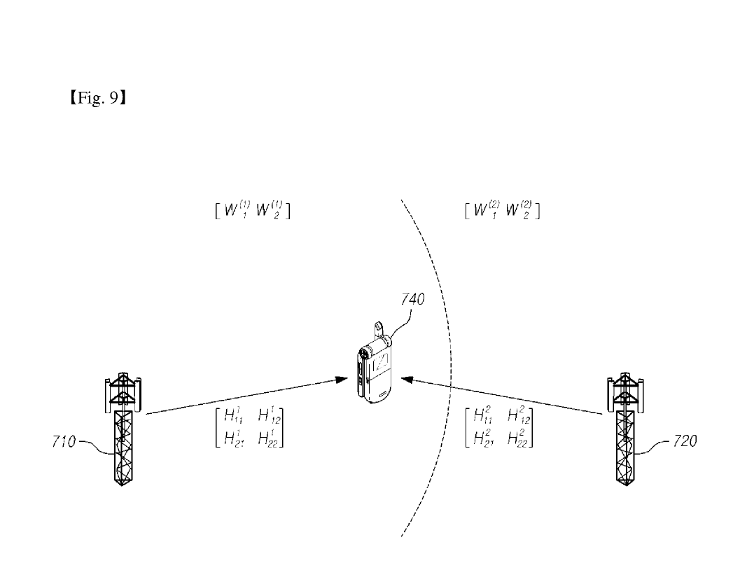

FIG. 9 is the downlink channel and the precoding matrices of the primary and the cooperative base stations in the wireless communication system using the MIMO CoMP operation of FIG. 7.

Referring to FIG. 7 and FIG. 9, The primary base station 710 may comprise a precoder 712 and a scheduler 714.

The scheduler 714 may receive the channel state information such as the PMIs and the CQI from the channel estimation 744 of the terminal 740. Then the scheduler 714 may transmit or forward the PMIs of the primary base station and the corresponding CQI to the cooperative base stations in the COMP set through X2 interface.

Based on the CSI feedback, the precoder 712 may precode the data symbols by the first and the second precoding matrices W1(1) and W2(1) corresponding to the PMIs received from the terminal. The precoder 712 may transmit the signal to the terminal with corresponding antennas such as 8 transmitting antennas.

The cooperative base station 720 may comprise a precoder 722 and a scheduler 724.

The scheduler 724 may directly receive its own second PMI from the terminal. The scheduler 724 may receive the PMIs of the primary base station and the corresponding CQI from the primary base station in COMP set through X2 interface. The scheduler 734 may induce the first PMI of the cooperative base station from the first PMI of the primary by using the relationship W₁⁽²⁾=mod(W₁⁽¹⁾+P,N) between the former and the latter.

The precoder 722 may precode the data symbols by both the first PMI of cooperative base station induced from the first PMI1(1) of the primary and the second PMI directly received from the terminal 740.

The precoder 722 may transmit the signal to the terminal with corresponding antennas such as 8 transmitting antennas.

Channel state information for the terminal according to another embodiment.

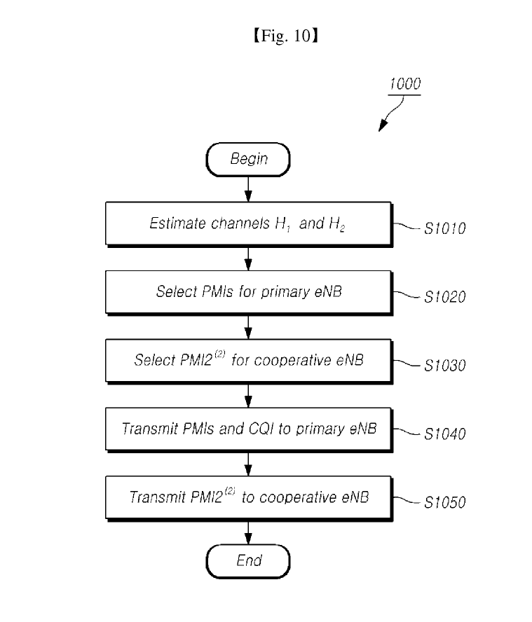

Referring to FIG. 10, in the method for feedbacking the channel information for the terminal according to another embodiment 1000, the terminal may estimate a downlink channels from all the base stations involved in COMP operation based on the reference signals such as CSI-RS (Channel status Indicator-Reference Signal) from both the primary base station and the cooperative base station at S1010. The terminal may be the terminal 740 and the base stations may be the base stations as drown in FIG. 2.

Based on the estimated channel, the terminal may select the best SU-MIMO PMIs for the primary base station at S1020. After the PMIs for the primary base station are decided, the terminal may select the PMI for the cooperative base station which can provide the maximum enhancement to signal of the primary base station at the UE side at S1030.

As described above, these two precoding scheme may be jointly performed by both of two precoding matrices. In this case the PMIs of the primary base station comes from

$$[ \begin{matrix}{W}_{1}^{( 1 )} & {W}_{2}^{( 1 )}\end{matrix} ] = {argmax}_{{{W}_{1} ∈ {C}_{1}}_{{W}_{2} ∈ {C}_{2}}} ( ‖ {H}_{1} {W}_{1} {W}_{2} ‖ )$$

the first PMI1(2) of the cooperative base station comes from W₁⁽²⁾=mod(W₁⁽¹⁾+P,N) and the second PMI2(2) for the cooperative base station does from

$${W}_{2}^{( 2 )} = {argmax}_{{W}_{2} ∈ {C}_{2}} ( ‖ {H}_{1} {W}_{1}^{( 1 )} {W}_{2}^{( 1 )} + {H}_{2} {W}_{1}^{( 2 )} {W}_{2} ‖ ) .$$

For example, when the PMIs for primary base station is PMI1(1)=1 and PMI2(1)=4, the PMIs for primary base station may be PMI1(2)=mod(1+16/2, 16)=9 and PMI2(2)=12.

After the terminal selects the PMIs for the primary base station and the second PMI2(2) for the cooperative base station, it may calculate the post SINR as CQI for the selected PMI when combine all the signals from all the base stations in the CoMP set.

Then the terminal feedback the PMIs of the primary base station and the corresponding CQI to the primary base station at S1040 and only feedback the second PMI2 to the cooperative base station at S1050. The terminal does not feedback the first PMI1(2) of the cooperative base station to any base stations in the CoMP set.

The channel state information may be possible for either periodic or aperiodic CQI reporting using the PUCCH or the PUSCH. The PMI is reported along with one or more the CQI and the RI but not limited thereof. The PMI is reported without other.

Before the primary and the cooperative base station may transmit the signals to the terminal, the terminal may estimate the precoded channel by DM-RS. When the primary and the cooperative base station may transmit the signals to the terminal the terminal may recover the original data symbols by post-decoder with precoded channel information although not drawn in Figures.

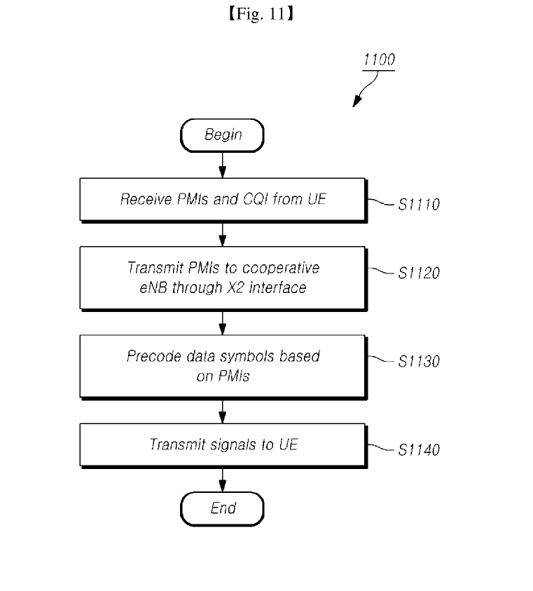

FIG. 11 is the flowchart of a method for processing the channel information and precoding the data symbols for the primary base station according to another embodiment.

Referring to FIG. 11, in the method for processing the channel information and precoding the data symbols for the primary base station according to another embodiment 1100, the primary base station may receive the channel state information such as the PMIs and the CQI from the terminal at S1110. The primary base station may be the primary base station of FIGS. 7 to 10.

Then the primary base station may transmit or forward the PMIs and CQI to the cooperative base stations in the COMP set through any kind of interface such as X2 interface at S1120.

Based on the CSI feedback, the primary base station may precode the data symbols by the first and the second precoding matrices W1(1) and W2(1) corresponding to the PMIs from the terminal at S1130. The precoder 722 may transmit the signal to the terminal with corresponding antennas such as 8 transmitting antennas at S1140.

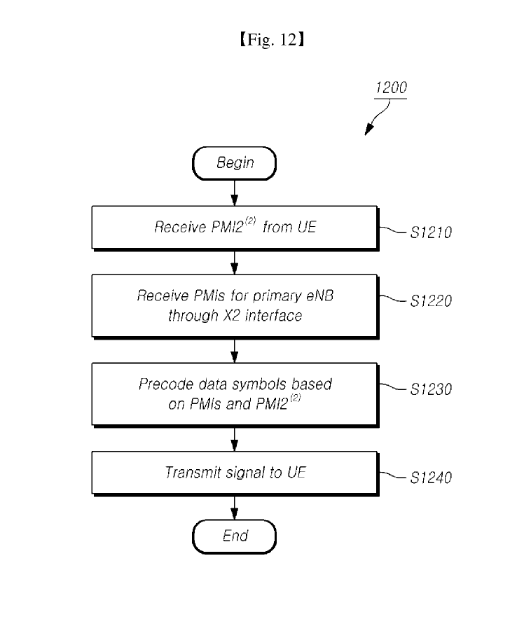

FIG. 12 is the flowchart of a method for processing the channel state information and precoding the data symbols for the cooperative base station according to another embodiment.

Referring to FIG. 12, in the method for processing the channel information and precoding the data symbols for the primary base station according to another embodiment 1200, the cooperative base station may directly receive its own second PMI from the terminal at S1205.

The cooperative base station may receive the PMIs of the primary base station and the corresponding CQI from the primary base station in the COMP set through X2 interface at S1210.

Based on the CSI feedback through X2 interface at S1210, the cooperative base station may induce the first PMI of the cooperative base station from the first PMI1(1) of the primary by using the relationship W₁⁽²⁾=mod(W₁⁽¹⁾+P,N) between the former and the latter at S1220.

The cooperative base station may precode the data symbols by both the first PMI1(2) of cooperative induced from the first PMI1(1) of the primary and the second PMI2(2) directly received from the terminal at S1230.

The cooperative base station may transmit the signal to the terminal with corresponding antennas such as 8 transmitting antennas at S1240.

As described above, a joint precoding scheme by two step PMI selection may reduce the feedback overhead of the channel state information and improve the system performance.

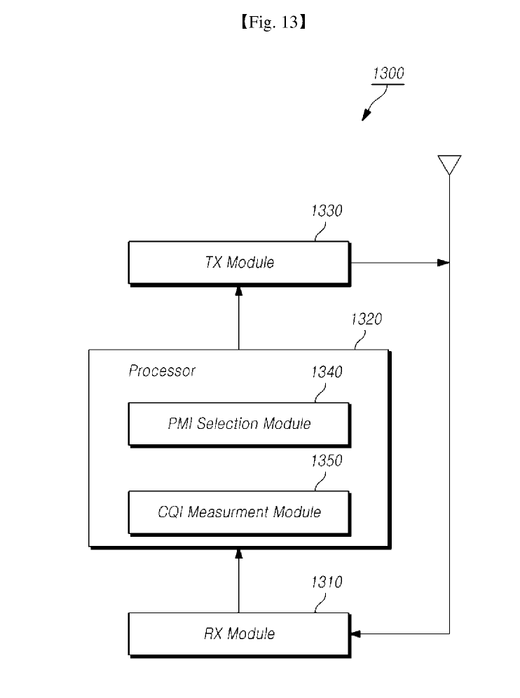

FIG. 13 is a block diagram of a UE apparatus according to an exemplary embodiment of the present invention.

Referring to FIG. 13, the UE apparatus 1300 includes a Reception (Rx) module 1310, a processor 1320, and a Transmission (Tx) module 1330. The processor 1320 may include a PMI selection module 1340 and a CQI measurement module 1350.

The Rx module 1310 may receive information about base stations included in the CoMP set in addition to general data transmitted by a base station. Particularly, the Rx module 1310 receives signals in the same frequency band from a primary base station and one or more cooperative base stations included in the CoMP set, which operate in joint processing mode.

The processor 1320 provides overall control to the UE apparatus 1300. Particularly, the PMI selection module 1340 of the processor 1320 selects a PMI for a base station. If the wireless communication system operates in joint processing mode, the PMI selection module 1340 may select the joint PMI of the favorite matrix in the high order configuration codebook for SU-MIMO operation corresponding to the channels between the terminal that receives data in the same frequency band and the base stations of the CoMP set. If one of the base stations has n Tx (n is one or more natural number) and the other of the base stations has m Tx (m is one or more natural number), the n+m Tx codebook may be used so that the PMI selection module 1340 may select the joint PMI from the high order configuration codebook for SU-MIMO operation.

The PMI selection module 1340 may select the PMIs of the primary base station W1(1) and W2(1) by means of

$$[ \begin{matrix}{W}_{1}^{( 1 )} & {W}_{2}^{( 1 )}\end{matrix} ] = {argmax}_{{{W}_{1} ∈ {C}_{1}}_{{W}_{2} ∈ {C}_{2}}} ( ‖ {H}_{1} {W}_{1} {W}_{2} ‖ )$$

and the second PMI2(2) for the cooperative base station by means of

$${W}_{2}^{( 2 )} = {argmax}_{{W}_{2} ∈ {C}_{2}} ( ‖ {H}_{1} {W}_{1}^{( 1 )} {W}_{2}^{( 1 )} + {H}_{2} {W}_{1}^{( 2 )} {W}_{2} ‖ ) .$$

The PMI selection module 1340 may automatically select the first PMI1(2) for the cooperative base station with the relationship W₁⁽²⁾=mod(W₁⁽¹⁾+P,N) between the first PMI1(1) and the first PMI1(2).

The CQI measurement module 1350 measures a CQI using a reference signal received from the Rx module 1310. Especially in the joint processing mode, the CQI measurement module 1350 measures a corresponding CQI for a plurality of reference signal in combination.

The Tx module 1330 may transmit a PMI and a CQI to an base station. When the wireless communication operates in the joint processing mode, the Tx module 1330 transmits either the joint PMI of the favorite matrix in the high order configuration codebook for SU-MIMO operation to the primary base station or the PMIs of the primary base station W1(1) and W2(1) by means of

$$[ \begin{matrix}{W}_{1}^{( 1 )} & {W}_{2}^{( 1 )}\end{matrix} ] = {argmax}_{{{W}_{1} ∈ {C}_{1}}_{{W}_{2} ∈ {C}_{2}}} ( ‖ {H}_{1} {W}_{1} {W}_{2} ‖ )$$

to the primary base station and the second PMI2 for the cooperative base station by means of

$${W}_{2}^{( 2 )} = {argmax}_{{W}_{2} ∈ {C}_{2}} ( ‖ {H}_{1} {W}_{1}^{( 1 )} {W}_{2}^{( 1 )} + {H}_{2} {W}_{1}^{( 2 )} {W}_{2} ‖ )$$

to the cooperative base station, which are selected by the PMI selection module 1340, the stream indexes, and the RI to the primary base station. The Tx module 1330 does not feedback the first PMI1(2) of the cooperative base station to any base stations in the CoMP set.

Especially in the joint processing mode, the Tx module 1330 transmits the corresponding CQI measured by the CQI measurement module 1350 to the primary base station.

The methods and systems as shown and described herein may be implemented in software stored on a computer-readable medium and executed as a computer program on a general purpose or special purpose computer to perform certain tasks. For a hardware implementation, the elements used to perform various signal processing steps at the transmitter (e.g., coding and modulating the data, precoding the modulated signals, preconditioning the precoded signals, and so on) and/or at the UE (e.g., recovering the transmitted signals, demodulating and decoding the recovered signals, and so on) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. In addition or in the alternative, a software implementation may be used, whereby some or all of the signal processing steps at each of the transmitter and terminal may be implemented with modules (e.g., procedures, functions, and so on) that perform the functions described herein. It will be appreciated that the separation of functionality into modules is for illustrative purposes, and alternative embodiments may merge the functionality of multiple software modules into a single module or may impose an alternate decomposition of functionality of modules. In any software implementation, the software code may be executed by a processor or controller, with the code and any underlying or processed data being stored in any machine-readable or computer-readable storage medium, such as an on-board or external memory unit.

Although the described exemplary embodiments disclosed herein are directed to various MIMO precoding systems and methods for using same, the present invention is not necessarily limited to the example embodiments illustrate herein. For example, various embodiments of a MIMO precoding system and design methodology disclosed herein may be implemented in connection with various proprietary or wireless communication standards, such as IEEE 802.16e, 3GPP-LTE, DVB and other multi-user MIMO systems. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for transmitting a channel state information at a terminal in a Coordinated Multi-Point (COMP) communication system, the method comprising:
receiving signals in a same frequency band from the base stations included in a CoMP set;
estimating a downlink channels from the received signals from the base stations; and
transmitting a joint PMI (precoding Matrix Index) from the high order configuration codebook to one base station among the base stations.

2. The method in claim 1, wherein if one of the base stations has n Tx and the other of the base stations has m Tx, the high order configuration codebook is a n+m Tx codebook corresponding to the (n+m) Tx.

3. The method in claim 2, wherein one of the base stations has 4Tx and the other of the base stations has 4Tx, the high order configuration codebook is a 8 Tx codebook.

4. The method in claim 2, wherein one base station is the primary base station.

5. A terminal for transmitting a channel state information at a terminal in a Coordinated Multi-Point (COMP) communication system, the method comprising:
a post decoder configured to recover a signals in a same frequency band from the base stations included in a CoMP set; and
a channel estimator configured to estimate downlink channels from a received signals from the base stations, transmit a joint PMI (precoding Matrix Index) from the high order configuration codebook to one base station among the base stations.

6. The terminal in claim 5, wherein if one of the base stations has n Tx and the other of the base stations has m Tx, the high order configuration codebook is a n+m Tx codebook corresponding to the (n+m) Tx.

7. The terminal in claim 6, wherein one of the base stations has 4Tx and the other of the base stations has 4Tx, the high order configuration codebook is a 8 Tx codebook.

8. The terminal in claim 5, wherein one base station is the primary base station.

9. A method for processing a channel state information at a base station in a Coordinated Multi-Point (COMP) communication system, the method comprising:
receiving a joint PMI (precoding Matrix Index) from the high order configuration codebook for base stations included in a CoMP set from a terminal;
transmitting the joint PMI to the cooperative base station among the base stations through an interface; and
precoding the data symbols by one part of a precoding matrix corresponding to the joint PMI.

10. A base station comprising:
a scheduler configured to receive a joint PMI (precoding Matrix Index) from the high order configuration codebook for base stations included in a CoMP set from a terminal and transmit the joint PMIs to the cooperative base station among the base stations through an interface; and
a precoder configured to precode the data symbols by one part of a precoding matrix corresponding to the joint PMI.

11. A method for processing a channel state information at a base station in a Coordinated Multi-Point (COMP) communication system, the method comprising:
receiving a joint PMI (precoding Matrix Index) from the high order configuration codebook for base stations included in a CoMP set from a primary base station through an interface; and
precoding the data symbols by one part of a precoding matrix corresponding to the joint PMI which is different from the other part of the precoding matrix by which the primary base station precodes the data symbols.

12. A base station comprising:
a scheduler configured to receive a joint PMI (precoding Matrix Index) from the high order configuration codebook for base stations included in a CoMP set from a primary base station through an interface; and
a precoder configured to precode the data symbols by one part of a precoding matrix corresponding to the joint PMI which is different from the other part of the precoding matrix by which the primary base station precodes the data symbols.

13. A method for transmitting a channel state information at a terminal in a Coordinated Multi-Point (COMP) communication system, the method comprising:
receiving signals in a same frequency band from the base stations included in a CoMP set;
estimating a downlink channels from the received signals from the base stations; and
transmitting two PMIs (precoding Matrix Indices) of a two stage precoding matrices for a primary base station to the primary base station and one PMI of one of two stage precoding matrices for a cooperative base station to the cooperative base station.

14. The method in claim 13, wherein one of two stage precoding matrices for the primary base station and the other of two stage precoding matrices for the cooperative base station are related to W₁⁽²⁾=mod(W₁⁽¹⁾+P, N) wherein the N is the codebook size and the P is equal to P=N/2.

15. The method in claim 14, wherein two stage precoding matrices for the primary base station comes from
$$[ \begin{matrix}{W}_{1}^{( 1 )} & {W}_{2}^{( 1 )}\end{matrix} ] = {argmax}_{{{W}_{1} ∈ {C}_{1}}_{{W}_{2} ∈ {C}_{2}}} ( ‖ {H}_{1} {W}_{1} {W}_{2} ‖ )$$
and one of two stage precoding matrices for the cooperative base station comes from
$${W}_{2}^{( 2 )} = {argmax}_{{W}_{2} ∈ {C}_{2}} ( ‖ {H}_{1} {W}_{1}^{( 1 )} {W}_{2}^{( 1 )} + {H}_{2} {W}_{1}^{( 2 )} {W}_{2} ‖ ) .$$

16. A terminal for transmitting a channel state information at a terminal in a Coordinated Multi-Point (COMP) communication system, the method comprising:
a post decoder configured to recover a signals in a same frequency band from the base stations included in a CoMP set; and
a channel estimator configured to estimate downlink channels from a received signals from the base stations and transmitting two PMIs (precoding Matrix Indices) of a two stage precoding matrices for a primary base station to the primary base station and one PMI of one of two stage precoding matrices for a cooperative base station to the cooperative base station.

17. The terminal in claim 16, wherein one of two stage precoding matrices for the primary base station and the other of two stage precoding matrices for the cooperative base station are related to W₁⁽²⁾=mod(W₁⁽¹⁾+P, N) wherein the N is the codebook size and the P is equal to P=N/2.

18. The terminal in claim 17, wherein two stage precoding matrices for the primary base station comes from
$$[ \begin{matrix}{W}_{1}^{( 1 )} & {W}_{2}^{( 1 )}\end{matrix} ] = {argmax}_{{{W}_{1} ∈ {C}_{1}}_{{W}_{2} ∈ {C}_{2}}} ( ‖ {H}_{1} {W}_{1} {W}_{2} ‖ )$$
and one of two stage precoding matrices for the cooperative base station comes from
$${W}_{2}^{( 2 )} = {argmax}_{{W}_{2} ∈ {C}_{2}} ( ‖ {H}_{1} {W}_{1}^{( 1 )} {W}_{2}^{( 1 )} + {H}_{2} {W}_{1}^{( 2 )} {W}_{2} ‖ ) .$$

19. A method for processing a channel state information at a base station in a Coordinated Multi-Point (COMP) communication system, the method comprising:
receiving two PMIs (precoding Matrix Indices) of a two stage precoding matrices for a primary base station included in a CoMP set from a terminal;
transmitting the first PMI to the cooperative base station through an interface; and
precoding the data symbols by two stage precoding matrices corresponding to two PMIs.

20. A base station comprising:
a scheduler configured to receive two PMIs (precoding Matrix Indices) of a two stage precoding matrices for a primary base station included in a CoMP set from a terminal and transmit two PMIs to the cooperative base station through an interface; and
a precoder configured to precode the data symbols by two stage precoding matrices corresponding to two PMIs.

21. A method for processing a channel state information at a base station in a Coordinated Multi-Point (COMP) communication system, the method comprising:
receiving the first PMI (precoding Matrix Indices) of a two stage precoding matrices for a primary base station included in a CoMP set from a primary base station through an interface;
receiving one PMI of one of two stage precoding matrices for a cooperative base station from a terminal; and
precoding the data symbols by both one precoding matrix induced from the first PMI for the primary base station and the other precoding matrix corresponding to one PMI received from the terminal.

22. A method for processing a channel state information at a base station in a Coordinated Multi-Point (COMP) communication system, the method comprising:
receiving the first PMI (precoding Matrix Indices) of a two stage precoding matrices for a primary base station included in a CoMP set from a primary base station through an interface;
receiving one PMI of one of two stage precoding matrices for a cooperative base station from a terminal; and
precoding the data symbols by both one precoding matrix induced from the first PMI for the primary base station and the other precoding matrix corresponding to one PMI received from the terminal.
